(19) United States
(12) Patent Application Publication
(10) Pub. No.: US 2015/0372387 A1
(43) Pub. Date: Dec. 24, 2015

(54) ANTENNA ARRANGEMENT OF A WIRELESS NODE

(71) Applicant: CAMBRIDGE COMMUNICATION SYSTEMS LIMITED, Cambridge (GB)

(72) Inventors: John David Porter, Cambridgeshire (GB); Stephen David Greaves, Cambridgeshire (GB)

(21) Appl. No.: 14/765,221

(22) PCT Filed: Jan. 31, 2014
(86) PCT No.: PCT/GB2014/000033

§ 371 Date: Jul. 31, 2015

(30) Foreign Application Priority Data
Feb. 1, 2013 (GB) 1301843.7

(51) Int. Cl. H01Q 13/02; H01Q 3/24; H01Q 21/20

(52) U.S. Cl. CPC H01Q 13/02; H01Q 21/20; H01Q 3/24

(57) ABSTRACT

A wireless node (10) comprises an RF modem (12), an RF switch array (14) connected to the RF modem, the RF switch array comprising a layer of circuit board sandwiched between layers of conductive material, and a plurality of antennas (16) arranged in a horizontal plane and connected to the circuit board of the RF switch array via waveguides present in the layers of conductive material. A method of operating the wireless node comprises generating radio signals at the RF modem (12), communicating the generated radio signals to the RF switch array (14), selecting an antenna (16) for transmitting the generated radio signals and transmitting the generated radio signals from the selected antenna.

This invention relates to a wireless node and to a method of operating the wireless node.

Wireless communication is very widely used in the developed world. For example, mobile telephones are virtually ubiquitous and are commonly carried by their users at all times. Such telephones are traditionally used for making and receiving telephone calls and sending and receiving short messages (SMS). The more advanced modern phones, often referred to as smartphones, have further provision for advanced data services such as the sending and receiving of emails and the accessing of wide area networks such as the Internet. Advances in wireless technology have resulted in a progression in the use of wireless standards from the original analogue service, through GSM and 3G to emerging 4G and related standards. These standards have led to the development of ever more capable handheld devices.

In conjunction with the advances in technology required of the handset, the increased usage of mobile phones and the more data intensive services that are now commonly used has led to an increased load on the infrastructure providing the wireless service. A mobile phone wireless network has been typically configured as a set of wireless base stations that cover one or more cells that are then connected into a wired backbone telecommunication service. As more and more demand is placed on the wireless network, then base stations are sited closer together with smaller cells. In urban areas in particular, given the high density of users, the locating of base stations is becoming a significant technical problem, given that a base station must have a wired connection into the wired backbone telecommunication service. It is not always possible to physically locate a base station in the precise location that would be desirable from the point of view of the wireless network provision.

It is therefore an object of the invention to improve upon the known art.

According to a first aspect of the present invention, there is provided a wireless node comprising an RF modem, an RF switch array connected to the RF modem, the RF switch array comprising a layer of circuit board sandwiched between layers of conductive material, and a plurality of antennas arranged in a horizontal plane and connected to the circuit board of the RF switch array via waveguides present in the layers of conductive material.

According to a second aspect of the present invention, there is provided a method of operating a wireless node comprising an RF modem, an RF switch array connected to the RF modem, the RF switch array comprising a layer of circuit board sandwiched between layers of conductive material, and a plurality of antennas arranged in a horizontal plane and connected to the circuit board of the RF switch array via waveguides present in the layers of conductive material, the method comprising the steps of generating radio signals at the RF modem, communicating the generated radio signals to the RF switch array, selecting an antenna for transmitting the generated radio signals and transmitting the generated radio signals from the selected antenna.

Owing to the invention, it is possible to provide a wireless node that is compact and easy to construct and can be used, for example, in conjunction with a base station to provide the route to a wired backbone that does not require the base station to be directly connected to the wired telecommunication network. The compact configuration of the wireless node, with the antennas arranged around an RF switch array, means that the wireless node can be easily sited in urban areas, with the plurality of antennas providing an excellent field of coverage. Multiple such nodes can be used together to provide a localised wireless provision that will create the interface between a wireless base station and the required wired telecommunication connection. The wireless node can be located on lampposts and other similar structures that are common and widespread in urban environments. The compact stack of circuit board and conductive (metal) layers contribute to achieving a fast switching speed that is essential to the performance of a system deploying the nodes. The “measurement, decision, switch” loop can be fast (100 ns) since the physical implementation of the antenna and RF switch does not introduce more latency than necessary.

Equipment to be co-located with smaller, densely distributed cellular base stations must be physically compact, low-cost, and as efficient as possible in their radio performance (through achieving fast switching in the S-TDMA implementation, and minimising loss in the RF path). The essence of the improved wireless node is therefore to achieve a compact, high performance wireless backhaul system which is also straightforward and cost-effective to manufacture. The improved wireless node preferably operates at frequencies in the 20 GHz to 60 GHz range, using a fast-switching S-TDMA operation and with a minimal loss RF switching arrangement that achieves high performance wireless links from a compact and cost effective physical structure.

The structure of the wireless node uses an RF switch array that is comprised of a circuit board that is sandwiched between two metal plates. The RF switch array is directly connected to the horizontal array of antennas, with waveguides being provided in the metal plates that transfer the RF signals from the circuit board to the antennas. This provides a robust and compact design which does not require any soldering of signal launches to the circuit board nor does it require any cabling connecting components together. The use of direct launch of signals from the circuit board to waveguide provides a reliable and low-loss distribution of the radio signals from the radio subsystem to a plurality of sectored antennas, in an instantiation that can be quickly assembled as a single stack of components. The metal plates provide good structural integrity for the node and also act as heatsinks to transfer heat generated by the components on the circuit board away from the RF switch array.

In a preferred embodiment, the wireless node comprises a series of layers. The layers of the wireless node are (from bottom to top), an interface board (power supply, weatherproof connectors and passive networking interface components), a digital processing board (CPU, memory, network switching, digital signal processing and analogue to digital conversions), a radio board (analogue radio from I/Q baseband to R/F, waveguide transitions), a duplexer with waveguide interfaces, a switch board with waveguide transitions and interfaces to duplexer and antennas and an antenna array.

Preferably, each antenna comprises a horn connected to the RF switch array at a proximal end of the horn and open at a distal end of the horn and preferably, adjacent antennas are in direct contact with each other. The configuration of the antennas as horns that are connected to the RF switch area at one end and open at the other end provides a simple and efficient arrangement of the antennas while also providing a wide field of view for the wireless output. The antennas are preferably slotted horn antennas which make it possible to build short antennas with high performance. In one embodiment, the antennas use only flat sheets that are bolted together and then bolted into the switch chassis. In a second embodiment, the antennas are built from only two elements, each of which is relatively easy to build on a CNC machine.

Advantageously, the antennas define an arc around the RF switch array greater than 180 degrees and less than 270 degrees. The antennas provide the field of view of the wireless node and the greater the field of view that is provided, the more flexibility that is delivered in the placing of the wireless nodes in order to provide the necessary routing. The antennas are placed in a horizontal plane around the central RF switch array, which results in the antennas being located in an arc around the RF switch array, and which controls which antenna is used according to the desired routing of the radio signals from the wireless node.

Ideally, the wireless node also comprises a base and a radome that contain the internal components of the wireless node. The RF subsystems form a central core of horizontal layers of circuit boards and aluminium material that are compact and easy to assemble. The antennas can be connected at the top of the component layers and all of these internal components can be located within the base and radome. The base and radome provide weather shielding of the internal components and also provide a way of dispersing heat from the components, when they are operational. The wireless node provides a stacked assembly of the internal components, a separation of electrical and thermal bonds and mating surfaces from the weatherproof seal and a simple build from the bottom up.

Embodiments of the present invention will now be described, by way of example only, with reference to the accompanying drawings, in which:—

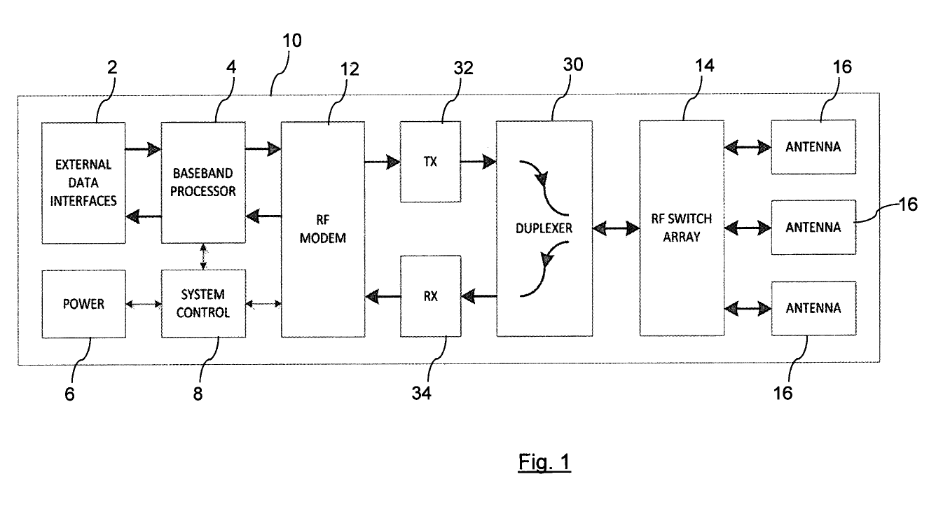

FIG. 1 is a schematic diagram of components of a wireless node,

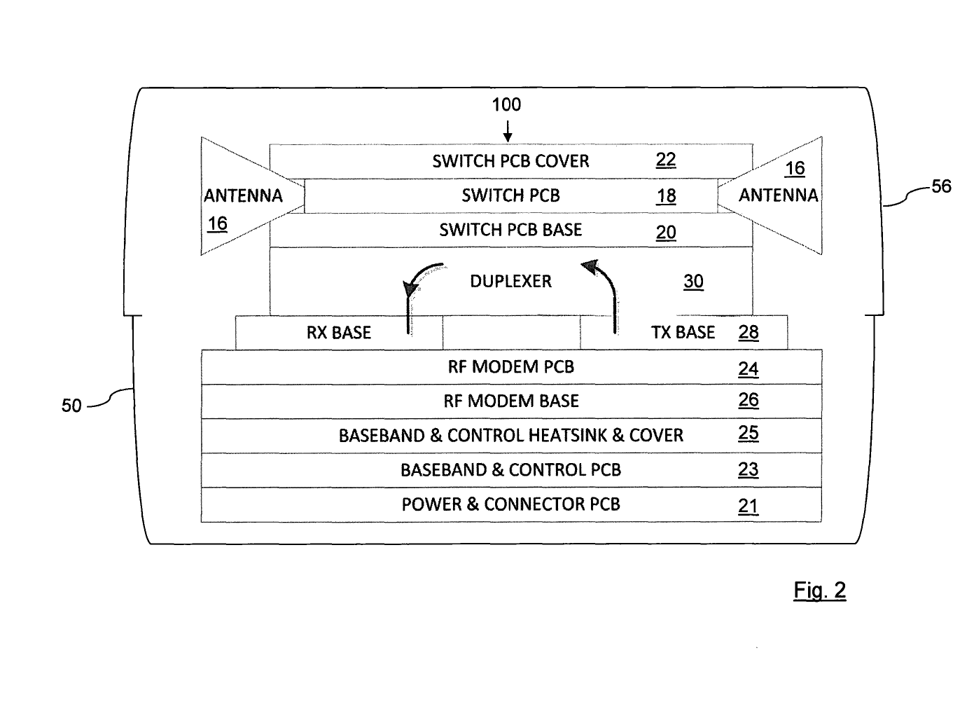

FIG. 2 is a further schematic diagram of components of the wireless node,

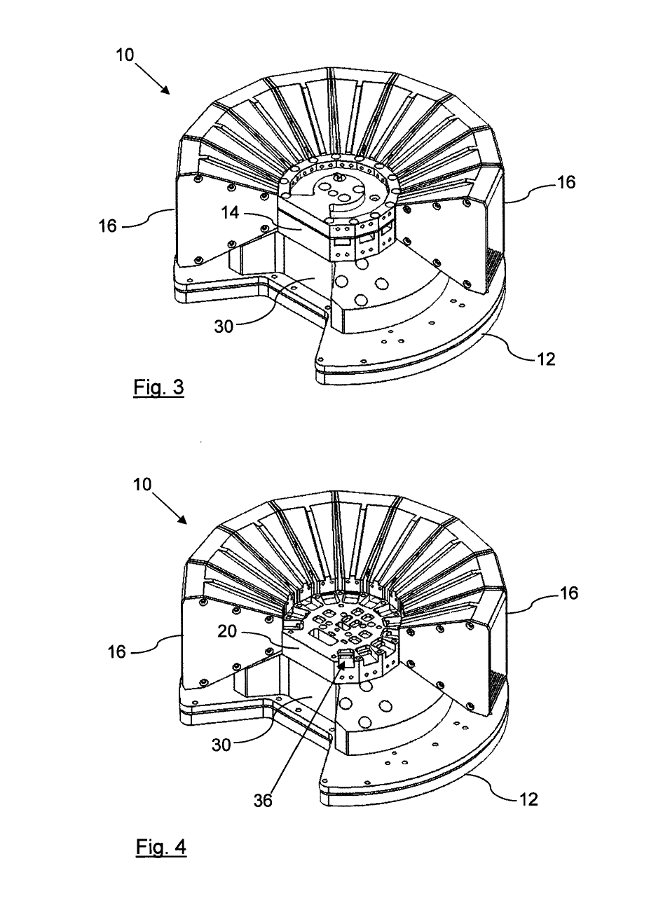

FIGS. 3 to 11 are perspective views of components of the wireless node,

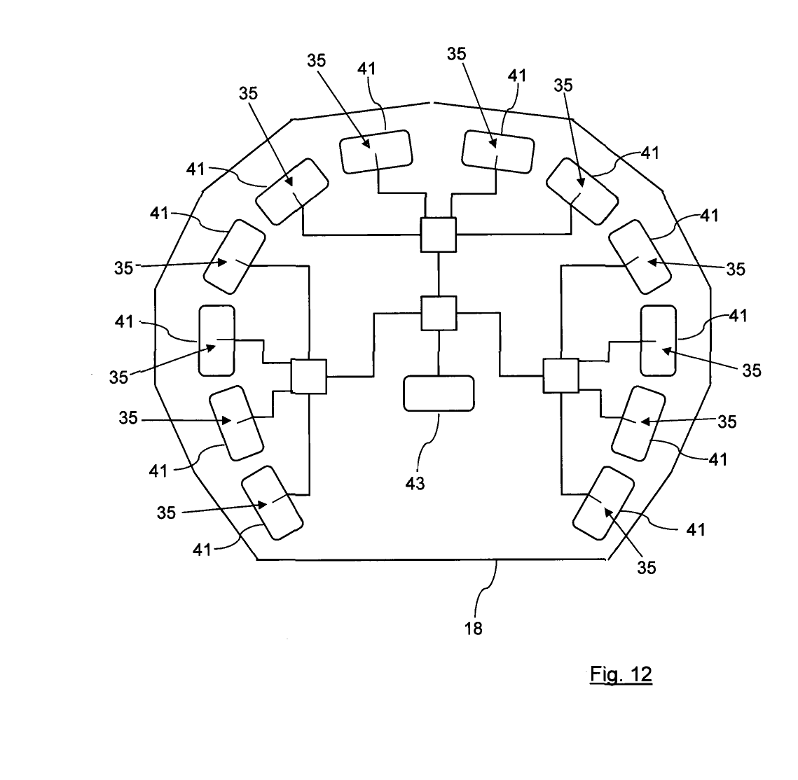

FIG. 12 is a plan view of a circuit board showing coupling probes connecting into antenna waveguides,

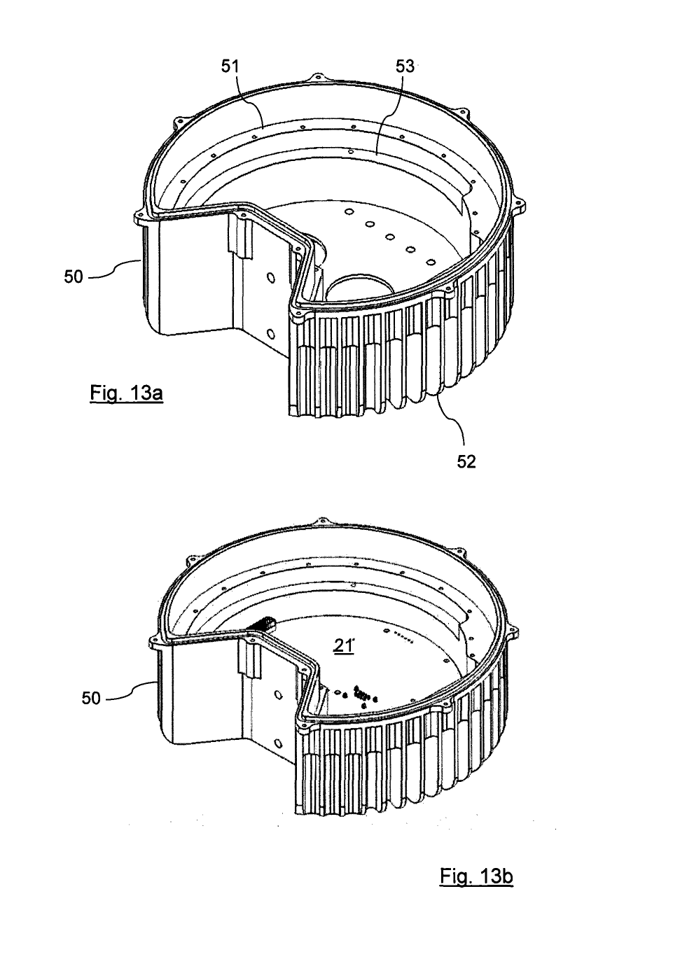

FIGS. 13 to 22 are perspective views of the wireless node as it is constructed, and

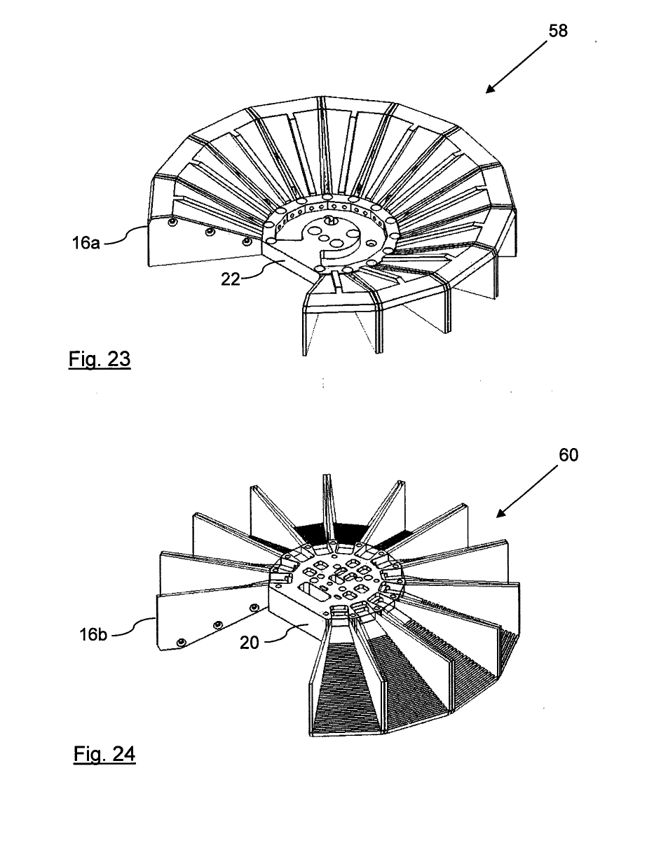

FIGS. 23 and 24 show perspective views of an alternative embodiment of the antennas.

FIG. 1 shows schematically components of a networked radio node 10. The wireless node 10 comprises a set of external data interfaces 2 that are connected to a baseband processor 4. A power supply 6 is connected to a system control component 8, which is also connected to the baseband processor 4. The wireless node 10 also comprises an RE modem 12 and an RF switch array 14 which is connected to the RF modem 12 through a duplexer 30 and a transmitter 32 and receiver 34. The RF modem 12 is also connected to the baseband processor 4 and the system control component 8. The node 10 also comprises a plurality of antennas 16 which are connected to the RF switch array 14. The antennas 16 are physically arranged around the RF switch array 14 in a horizontal plane, as can be seen in FIG. 3. The wireless node 10 comprises a central core of interlocking horizontal layers of circuit boards and conductive material (such as a suitable metal), which make up the components of FIG. 1, with the exception of the antennas 16.

The RF subsystems for the node 10 are configured and arranged in a novel and clever manner that achieve a number of system critical objectives that provide an optimum pair of signal paths that keep the transmit and receive RF signal loss to a minimum. Waveguides are used to convey RF energy from one point in the RF system to another. Where RF energy is required to transition to, be carried on or transition off a circuit board (PCB) assembly, all waveguide transitions are implemented as an integral part of the PCB. No soldering of waveguides to any of the PCB assemblies is required. The node 10 is constructed from circuit boards and aluminium layers.

The RF subsystem, at an RF building block level consists of the transmitter 32, receiver 34, duplexer 30, multi-way antenna switch 14 and an array of antennas 16 configured to provide horizontal plane angular coverage between 180 and 270 degrees. The mechanical implementation and the resulting stacked assembly of the RF subsystem blocks provide a novel and elegant simplicity to the design of the node 10. The duplexer 30 comprises two uni-directional ports and one bidirectional port. One uni-directional port is connected to the transmitter 32 and the other uni-directional port is connected to the receiver 34. The bidirectional port of the duplexer 30 is connected to the RF switch array 14.

FIG. 2 shows schematically the physical arrangement of the components within the node 10, which comprises the central core 100 and the antennas 16, contained within a base 50 and a radome 56. At the bottom of the central core 100 is a power and connector PCB 21 (containing the external data interfaces 2 and the power supply 6), a baseband and control PCB 23 (containing the baseband processor 4 and the system control 8) and a baseband and control heatsink and cover 25. Above this is the RF modem 12, which comprises three horizontal layers of a circuit board 24 sandwiched between layers of conductive material, being the RF modem base 26 and the RX and TX cover 28. Cavities in the RF modem base 26 and RX/TX cover 28 form waveguides that are coupled into by PCB trace probes etched on the RF modem PCB 24, allowing the transmitter 32 to send RF power and the receiver 34 to receive RF signals.

The machined cavities in the RX cover and TX cover 28 (which are formed as a single continuous block) and the duplexer base block 30 continue the waveguides, connecting the bidirectional port of the duplexer 30 to the common point of the RF switch array 14. The duplexer structure 30 itself is formed from a complex arrangement of tuneable cavities and waveguide sections. The RF switch array 14 comprises three horizontal layers of a circuit board 18 sandwiched between layers of conductive material, the switch PCB base 20 and the switch PCB cover 22. Cavities in the duplexer base and cover 30 form waveguides that are coupled into by PCB trace probes on the switch PCB 18.

The switch PCB cover 22, and base 20, form waveguides from the switched nodes to each of the antennas 16 that connect to the system, with PCB probes again coupling the switched RF signal to resulting waveguides. The RF switch array 14 selects an antenna 16 from the array of antennas 16 that are arranged around the RF switch array 14 to use for the RF transmissions. The antennas 16 are so arranged to provide a wide field of view and the appropriate antenna 16 is selected by the RF switch array 14 according to the routing of the transmitted radio signal. Waveguides in the central core 100 transmit the RF energy through the node 10.

FIG. 3 shows an assembly drawing of part of the wireless node 10. The Figure shows the complete assembly of modem 12, duplexer 30, RF switch array 14 and some of the horn antennas 16. Three of the antennas 16 have been removed to make the rest of the assembly more visible. Each antenna 16 comprises a horn 16 connected to the RF switch array 14 at a proximal end of the horn 16 and open at a distal end of the horn 16. There are twelve antennas 16 in total, in a horizontal array around the RF switch array 14 and they provide 270 degrees coverage. Adjacent antennas 16 are in direct contact with each other.

FIG. 4 shows the same view of FIG. 3, but with the switch cover 22 and PCB 18 removed from the RF switch array 14. Visible are waveguides 36 located within the switch PCB base 20 that connect the circuit board 18 of the RF switch array 14 to the antennas 16. Each antenna 16 has a respective waveguide 36 that receives the RF energy carrying the transmitted radio signal from the RF switching array 14. Received radio signals travel in reverse from the antenna 16 to the respective waveguide 36 in the RF switch array 14. Other waveguides are also visible in the switch PCB base 20 that carry RF energy between components in the node 10.

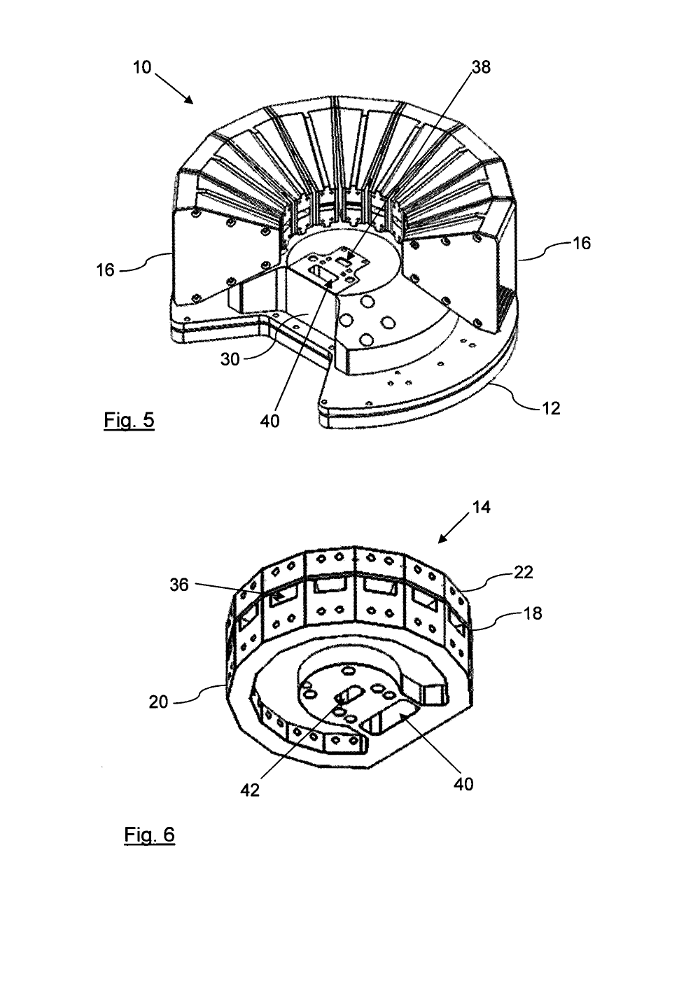

FIG. 5, shows a view similar to FIG. 4 of the internal components of the wireless node 10, but with the switch base 20 removed from the central core 100. The top of the duplexer 30 is shown. The single bi-directional waveguide port 38 on the top of the duplexer can be seen. RF energy passes through the port 38 to and from the RF switch array 14. The larger hole 40 is used to guide cables from the RF modem PCB 24 and below to the space above the switch PCB cover 22. This hole 40 is present in all of the components that make up the central core 100, in the same position.

FIG. 6 shows the combined assembly of switch PCB cover 22, switch PCB 18 and antenna mount plate 20, from below. These are the components of the central core 100 that are not shown in FIG. 6 and form the RF switch array 14. The bidirectional waveguide port 42 which directs RF energy to and from the duplexer 30 is also shown. The openings of the waveguides 36 from the RF switch array 14 to the antennas 16 can also be seen in this Figure. There are twelve such waveguides 36 in the RF switch array 14, each dedicated to a respective antenna horn 16. The hole 40 through the RF switch array 14 can also be seen.

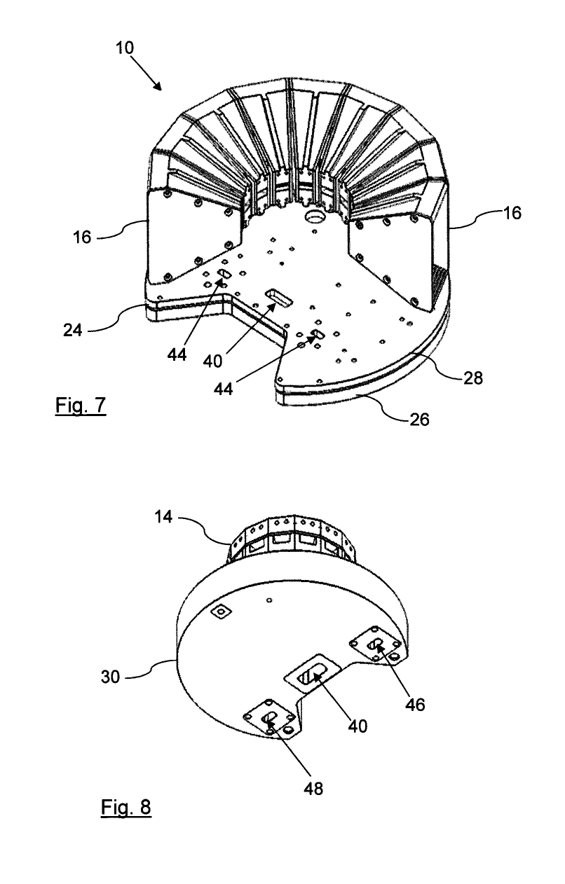

FIG. 7 shows the upper lid 28 of the RF modem 12. In addition to providing RF shielding and forming part of the waveguide, this plate 28 also helps remove heat from the RF modem 12. The duplexer 30 and the other components of the central core 100 above the RF modem 12 have been removed from this Figure. The hole 40 can be seen and the two uni-directional ports 44 from the RF modem 12 to the duplexer 30 can be seen. The RF modem 12 comprises two horizontal plates of aluminium with the circuit board 24 sandwiched in-between. The aluminium plates 26 and 28 include multiple waveguides transferring the RF energy to and from the circuit board 24.

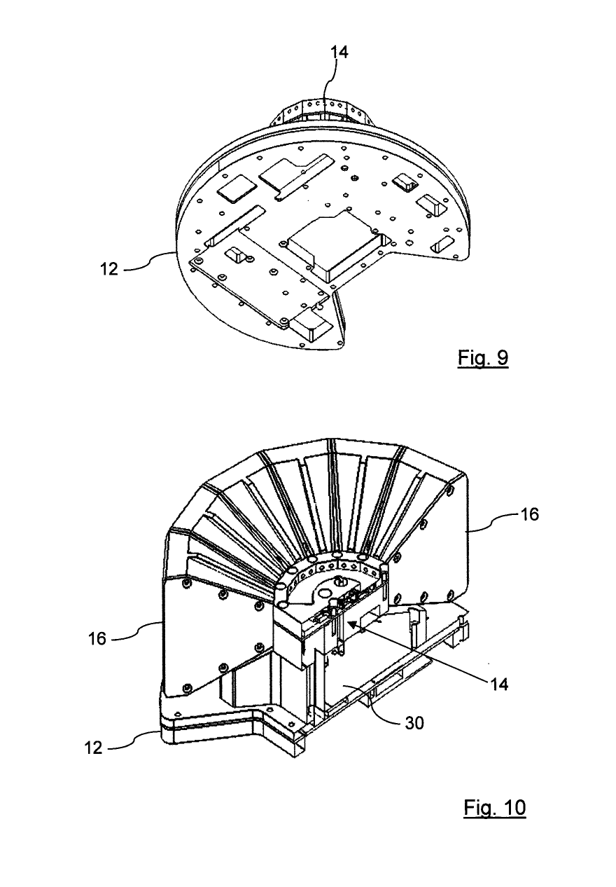

FIG. 8 shows the duplexer 30 and RF switch array 14 viewed from below. The uni-directional waveguide ports 46 and 48 that connect to the transmitter 32 and receiver 34 of the RF modem 12 are shown. The hole 40 that runs through the whole of the central core 100 can also be seen. The duplexer 30 transfers RF energy to and from the RF modem 12 and the RF switch array 14. In FIG. 9, for completeness, the RF modem 12 and switch assembly 14 are shown, viewed below with antennas 16 removed for clarity. The milled aluminium bottom surface of the RF modem base 26 has recesses created therein to create space for additional components.

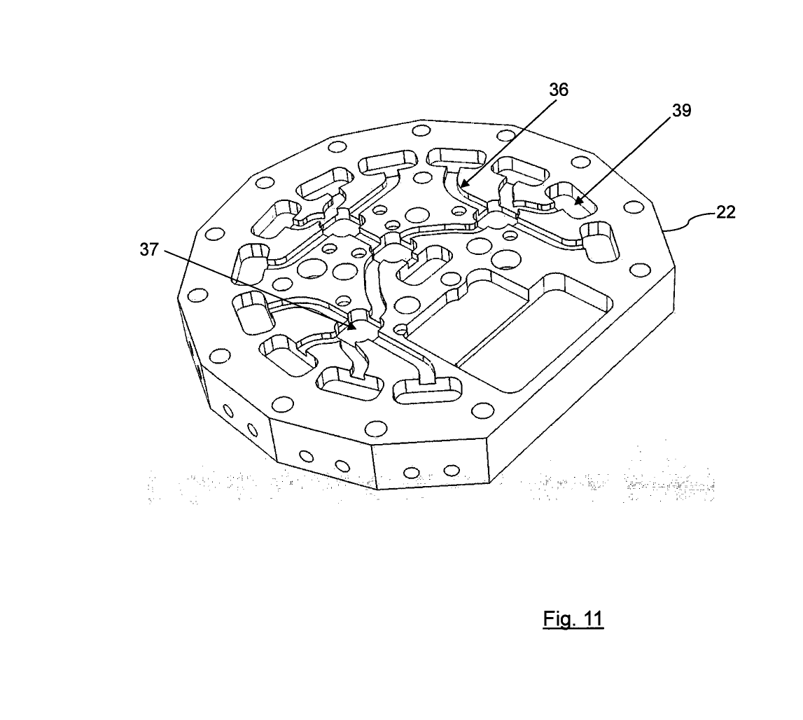

FIG. 10 shows a cross-section of the assembly of the wireless node 10, which comprises the central core 100 and the antennas 16, which are connected around the RF switch array 14 of the central core 100. The central core 100 of the wireless node 10 comprises interlocking horizontal layers of circuit boards and conductive material, from bottom to top, an RF modem 12, a duplexer 30 connected to the RE modem 12 and an RF switch array 14 connected to the duplexer 30. RF energy is transferred around the central core 100 using waveguides cut into the layers of conductive material. The waveguides transfer RF energy between different components and also around the same component.

The wireless node 10 has several important aspects including the stacked assembly of the components that make up the central core 100, the fact that the PCB assemblies are sandwiched between machined faces eliminating soldered RF connections, the RF waveguides are implemented as channels within mechanical components rather than discrete waveguide elements mounted on a PCB and all RF transitions into and out of waveguides are solder free and formed by probes constructed from POCB traces. The wireless node 10 is compact and can be mounted unobtrusively without requiring a large footprint. The wireless node 10 is suitable for forming part of a network of nodes 10 that can be used, for example, to connect a 3G or 4G wireless base station to a wired broadband connection.

FIG. 11 shows the switch cover 22, viewed from below. The switch cover 22, like the other conductive layers in the central core 100 of the node 10 is formed from aluminium and has material removed to form waveguides 36 in the switch cover 22 and to create space 37 for components that are located on the switch circuit board 18. The holes 39 provide the transition from the switch PCB 18 to the waveguides that lead to the antennas 16. As mentioned above, the RF switch array 14 is comprises of three horizontal layers, with the switch cover 22 forming the topmost layer. The circuit board 18 is sandwiched between the switch cover 22 and the switch base 20. Waveguides 36 are present in the layers 20 and 22 to receive and transmit RF energy from the circuit board 18 of the RF switch array 14.

FIG. 12 shows a view of the top of the switch PCB 18, which connects to the waveguide transitions 39 that in turn drive the antenna horns 16. FIG. 11 shows the underside of the switch PCB cover 22, which sits on top of the switch PCB 18. The waveguides 36 in the switch PCB base 20 direct the RF energy from the switch array 14 into the antennas 16. PCB/microstrip coupling probes 35 in etched portions 41 on the upper side of the switch PCB 18 are used together with critical depth compartments in the switch lid 22 to transfer the RF energy into the waveguides 36 contained in the switch base 20. The switch PCB 18 comprises a cascade of multipole RF switches that route the bidirectional RF energy to and from the antennas 16 using the waveguide transitions 39 on the switch lid 22. A common port 43 is connected to a waveguide transition in the centre of the switch lid 22 which connects the antenna waveguides 36 and the common port waveguide 42 on the switch base 20.

The wireless node 10 also comprises an aluminium base and plastic cover to protect the internal components from the elements. FIGS. 13 to 22 show the mechanical layout and assembly of the wireless node 10 in stages. The product is designed and manufactured in a way that allows it to be very easily manufactured and assembled without requiring complex electronic or other alignment tools. The components selected allow the necessary mechanical robustness, allow for heat conduction out of the assembly and provide the necessary weather proofing. The components that form the internal parts of the wireless node 10 are built up in interlocking layers, which makes the node 10 easy to assemble.

In FIG. 13a, the process of assembling the wireless node 10 starts with the provision of a deep aluminium base 50, which is waterproof and is provided with external fins 52 to aid in dissipating heat from the contained internal electronics. The deep shoulders 51 and 53 allow heat to be transferred from the various covers and heat-sink plates (once in place) to the finned aluminium base 50. The base 50 is made from a single cast and/or milled piece of aluminium and has the internal ledges 51 and 53 that are designed so that specific horizontal layers of the internal components will rest on those ledges, thereby locating those components and also providing excellent heat conductivity away from the component connected in this way. RF shielding is also provided by creating a simple electrically conductive seal, when a component is located on a ledge. In FIG. 13b, the power and connector PCB 21 can be seen, located at the bottom of the base 50. The connectors can be seen projecting through the base and their interface PCB.

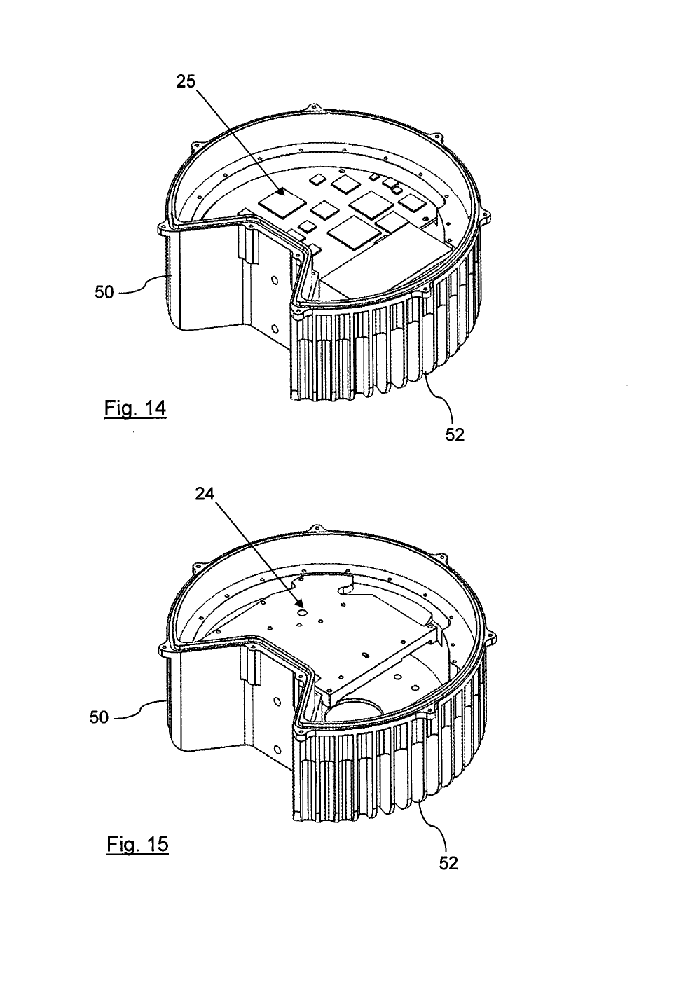

In FIG. 14, the baseband and control board 23 and the heatsink and cover 25 is inserted into the base 50 and connected as required. The heatsink and cover 25 makes contact with the shoulder 53 of the deep base 50 allowing heat transfer to the base 50. In FIG. 15, the RF modem base 26 and RF modem PCB 24 of the RF modem 12 are installed on top of the control board 54. These two components can be added in turn or as a single unit depending upon how they are manufactured. The internal shape and size of the base 50 ensures that the components are correctly located as they are added into the base 50. The central core 100 of components is created as the horizontal layers are added in turn to the base 50.

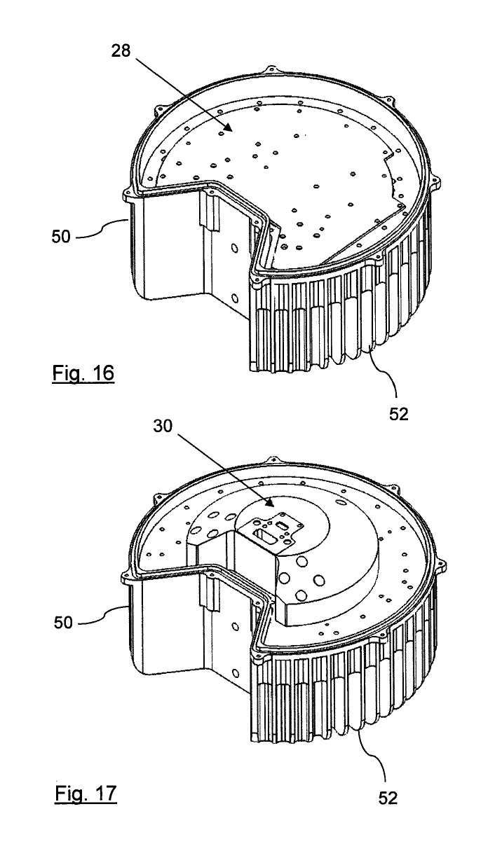

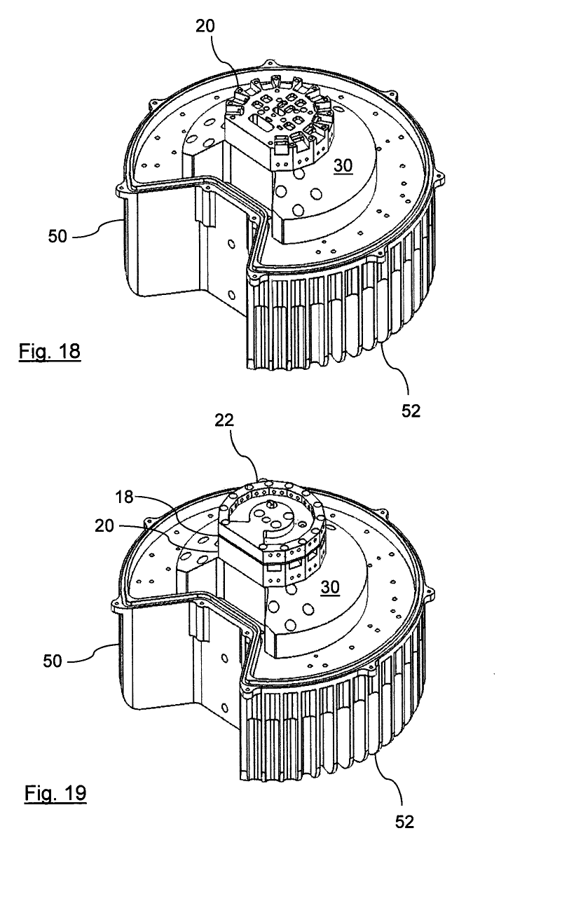

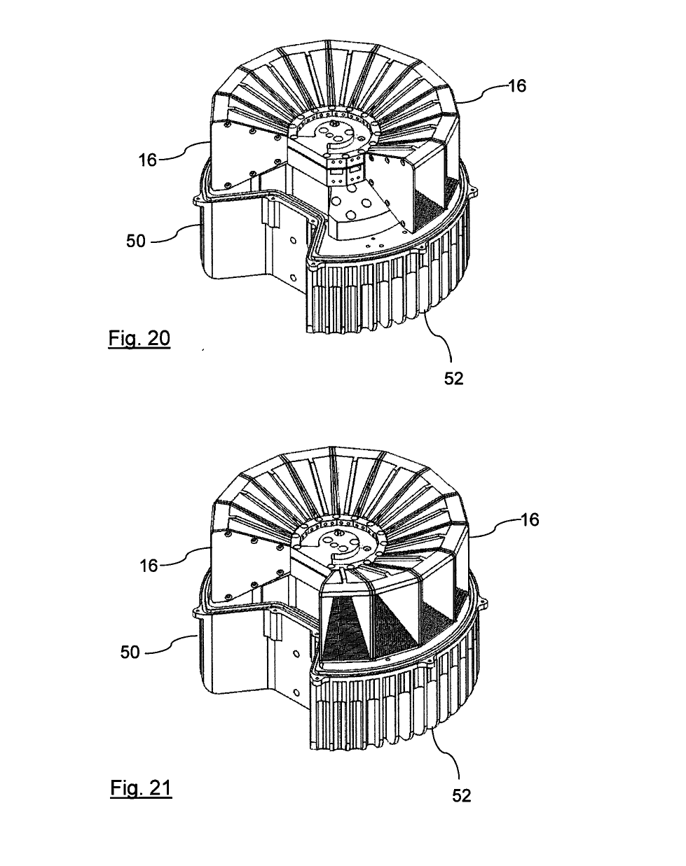

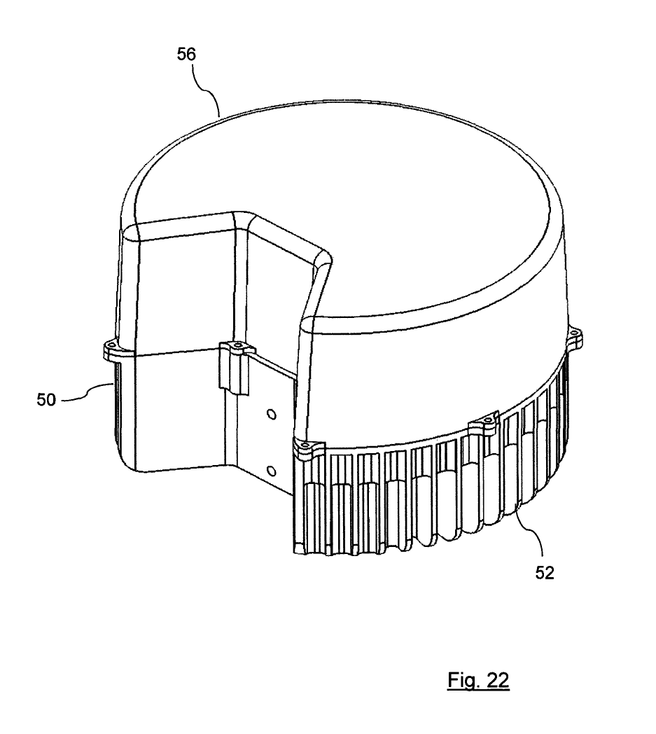

In FIG. 16, the aluminium cover 28 is next inserted into the base 50 of the wireless node 10. The cover 28 provides mechanical stability and thermal conductivity. The cover 28 makes contact with the shoulder 51 of the deep base 50 in allowing heat transfer to the base 50. In FIG. 17, the duplexer 30 is added and in FIG. 18 the switch assembly 20 is added. In FIG. 19, the switch PCB 18 and the switch assembly cover 22 is added. In FIG. 20, the RF antenna horns 16 are attached to the RF switch array 14. FIG. 21 shows the wireless node 20 with the central core 100 and the antennas 16 completed. It can be seen that there is space above the horn antenna assembly to insert and mount other electronics, if needed. In FIG. 22, a plastic radome 56 is fitted, completing the weatherproofing of the wireless node 10. The wireless node 10 provides a stacked assembly of the internal components, a separation of electrical and thermal bonds and mating surfaces from the weatherproof seal and simple build from the bottom up assembly.

In the above description, the horn antennas 16 are each manufactured individually from a set of four plates that are fixed together to form a single horn antenna 16. The horn antennas 16 are then individually attached to the central core 100. FIGS. 23 and 24 show an alternative arrangement for the manufacture of the antennas 16 of the wireless node 10. The antenna structure, in this alternative embodiment, is made from two cast and machined components 58 and 60, which are shown in the FIGS. 23 and 24. FIG. 23 shows the top section 58, which consists of the switch PCB cover 22 and the top portion 16a of the horn antennas 16 and FIG. 24 shows the bottom section 60, which consists of the switch PCB base 20 and the bottom portion 16b of the horn antennas 16. These two components 58 and 60 would be cast as shown, with minor machining to ensure that the mating surfaces are true. The switch PCB 18 would be sandwiched between the two components 58 and 60, which all together would form the RF switch array 14 and the antennas 16.

1. A wireless node comprising:
an RF modem,
an RF switch array connected to the RF modem, the RF switch array comprising a layer of circuit board sandwiched between layers of conductive material, and
a plurality of antennas arranged in a horizontal plane and connected to the circuit hoard of the RF switch array via waveguides present in the layers of conductive material.

2. A wireless node according to claim 1, wherein each antenna comprises a horn connected to the RF switch array at a proximal end of the horn and open at a distal end of the horn.

3. A wireless node according to claim 1, wherein the antennas define an arc around the RF switch array greater than 180 degrees.

4. A wireless node according to claim 1, wherein the antennas define an arc around the RF switch array less than 270 degrees.

5. A wireless node according to claim 1, wherein adjacent antennas are in direct contact with each other.

6. A wireless node according to claim 1, wherein the RF modem comprises three horizontal layers of a circuit board sandwiched between layers of conductive material.

7. A wireless node according to claim 1, and further comprising a duplexer connected between the RF modem and the RF switch array.

8. A method of operating a wireless node comprising an RF modem, an RF switch array, connected to the RF modem, the RF switch array comprising a layer of circuit board sandwiched between layers of conductive material, and a plurality of antennas arranged in a horizontal plane and connected to the circuit board of the RF switch array via waveguides present in the layers of conductive material the method comprising the steps of generating radio signals at the RF modem, communicating the generated radio signals to the RF switch array, selecting an antenna for transmitting the generated radio signals and transmitting the generated radio signals from the selected antenna.

9. A method according to claim 8, wherein each antenna comprises a horn connected to the RE switch array at a proximal end of the horn and open at a distal end of the horn.

10. A method according to claim 8, wherein the antennas define an arc around the RF switch array greater than 180 degrees.

11. A method according to claim 8, wherein the antennas define an arc around the RF switch array less than 270 degrees.

12. A method according to claim 8, wherein adjacent antennas are in direct contact with each other.

13. A method according to claim 8, wherein the RF modem comprises three horizontal layers of a circuit board sandwiched between layers of conductive material.

14. A method according to claim 8, and further comprising a duplexer connected between the RF modem and the RF switch array.
